(19) United States
(12) Patent Application Publication
(10) Pub. No.: US 2015/0161796 A1
(43) Pub. Date: Jun. 11, 2015

(54) METHOD AND DEVICE FOR RECOGNIZING PEDESTRIAN AND VEHICLE SUPPORTING THE SAME

(71) Applicant: Hyundai Motor Company, Seoul (KR)

(72) Inventors: Eun Jin Choi, Seoul (KR); Jae Kwang Kim, Seoul (KR); Jin Hak Kim, Suwon (KR); Wan Jae Lee, Suwon (KR); Kang Hoon Lee, Yongin (KR)

(21) Appl. No.: 14/309,146

(22) Filed: Jun. 19, 2014

(30) Foreign Application Priority Data
Dec. 9, 2013 (KR) 10-2013-0152296

(51) Int. Cl. G06T 7/00; H04N 7/18; H04N 5/33

(52) U.S. Cl. CPC G06T 7/0048; H04N 5/33; H04N 7/18

(57) ABSTRACT

A method and a device for recognizing a pedestrian and a vehicle supporting the same are provided. The method includes collecting, by a controller, a far-infrared image using a far-infrared imaging device and detecting a pedestrian candidate group from the far-infrared image. In addition, the method includes extracting, by the controller, pedestrian features based on previously normalized pedestrian database (DB) learning and comparing the pedestrian features with the pedestrian DB learning results to determine similarity. The controller is configured to perform pedestrian recognition based on the comparison result.

### CROSS-REFERENCE TO RELATED APPLICATION

This application is based on and claims priority from Korean Patent Application No. 10-2013-0152296, filed on Dec. 9, 2013 in the Korean Intellectual Property Office, the disclosure of which is incorporated herein in its entirety by reference.

### BACKGROUND

1. Field of the Invention

The present invention relates to a technique of recognizing a pedestrian and appropriately responding when a pedestrian is detected, and more particularly, to a method and a device for recognizing a pedestrian that more reliably recognizes a pedestrian ahead of a vehicle and more appropriately adjusts a speed of a vehicle, and a vehicle supporting the same.

2. Description of the Prior Art

Many fatal accidents, among vehicle accidents, occur due to failure of recognizing a pedestrian in front of a vehicle at night (e.g., poor lighting conditions). In particular, for nighttime driving, a driver has a more narrow field of vision thus making it difficult to predict the presence or absence or a movement of a pedestrian in front of a vehicle. Accordingly, a scheme of collecting various sensor signals and recognizing a pedestrian ahead at night based on the collected sensor signals has been proposed.

For example, a related art pedestrian recognition technique includes a method of drawing (e.g., extracting) contour features known as histogram of gradients (HOG) based on a database (DB) image previously obtained in relation to a pedestrian and employing a classifier (e.g., support vector machine (SVM) classifier) to determine whether an object is a pedestrian or a non-pedestrian. However, but since a substantial amount of features are required to be compared in the method of the related art, a detection speed is substantially low, making it difficult to provide appropriate information at a required timing. To complement this, an Adaboost scheme employing a weaker classifier may be applied. In particular, a processing speed may be improved but detection performance is degraded less than necessary, making it difficult to properly recognize a pedestrian. Further, an application of the weaker classifier scheme may cause substantial errors in pedestrian recognition performance to provide effective functions.

### SUMMARY

Accordingly, the present invention provides a device and a method for recognizing a pedestrian that may achieve an improved image process speed and more stably recognize a pedestrian, and a vehicle supporting the same.

In one aspect of the present invention, a device for recognizing a pedestrian may include a far-infrared imaging device (e.g., a camera, video camera, etc.) configured to collect a far-infrared image of a predetermined area; and a controller configured to detect a pedestrian candidate group from the far-infrared image, extract and compare pedestrian features based on primary features among features detected by a substantially weak classifier, while learning normalized pedestrian database (DB), to perform pedestrian detection.

The controller may be configured to perform pedestrian candidate group detection based on temperature information and head information (e.g., different parts of a pedestrian) in the far-infrared image. The controller may also be configured to determine a surrounding area of the pedestrian candidate group detected from the far-infrared image, and normalize the surrounding area of the pedestrian candidate group to have a size of a pedestrian area in the normalized pedestrian DB. The controller may be configured to normalize the surrounding area of the pedestrian candidate group to have a size with a ratio of 1:2 in width and height. In addition, controller may be configured to apply an Adv_HOG (advanced Histogram of Oriented gradients) scheme in which the pedestrian candidate group area is divided into square blocks adjustable in size and an angle range of 360 degrees may be divided into nine bins to express angles, or may be configured to apply a local binary pattern (LBP) scheme in which a value obtained by pattern changes in a current pixel value and a neighbor pixel value is applied to each block having an adjustable size in the pedestrian candidate group area to configure a histogram to draw features. The controller may be configured to perform clustering on an area in which objects overlap in the pedestrian detection result image to determine whether a single pedestrian is present or a plurality of pedestrians are present.

In another aspect of the present invention, a vehicle supporting a pedestrian recognition function may include: a far-infrared imaging device configured to collect a far-infrared image of a predetermined area; a controller configured to detect a pedestrian candidate group from the far-infrared image, extract and compare pedestrian features based on primary features among features detected by a substantially weak classifier, while learning normalized pedestrian database (DB), to perform pedestrian detection; and an information output device configured to output the pedestrian detection result.

The information output device may include at least one of an audio device configured to output an alarm sound according to at least one of a distance between the pedestrian and a vehicle and a position of the pedestrian; and a video device configured to output the pedestrian detection image. In addition, the vehicle may further include: at least one of a timer configured to determine a time at which the pedestrian recognition function is automatically applied, an luminance sensor and a temperature sensor configured to detect an environment in which the pedestrian recognition function is automatically applied.

In another aspect of the present invention, a method for recognizing a pedestrian may include: collecting a far-infrared image; detecting a pedestrian candidate group from the far-infrared image; extracting pedestrian features based on previously normalized pedestrian database (DB) learning; comparing the pedestrian features with the pedestrian DB learning results to determine similarity; and performing pedestrian recognition based on the comparison result. The detecting process may be may include performing the pedestrian candidate group detection based on temperature information and head information from the far-infrared image.

The method may further include: determining a surrounding area of the pedestrian candidate group detected from the far-infrared image; and normalizing the surrounding area of the pedestrian candidate group such that it corresponds to a size of a pedestrian area in a normalized pedestrian database and has a size with a ratio of 1:2 in width and length. The feature extraction process may include: extracting primary features among features extracted by a substantially weak classifier during the database learning process. The feature extraction process may further include: at least one of applying an Adv_HOG (advanced Histogram of Oriented gradients) scheme in which the pedestrian candidate group region is divided into square blocks changeable in size and an angle range of 360 degrees is configured as 9 bins to express angles, and applying a local binary pattern (LBP) scheme in which a value obtained by pattern changes in a current pixel value and a neighbor pixel value is applied to each block having an adjustable size in the pedestrian candidate group area to configure a histogram to extract features.

The method may further include: determining whether a single pedestrian is present or a plurality of pedestrians are present with respect to an area in which detection objects overlap in the pedestrian detection result image. Additionally, the method may include: at least one of outputting an alarm sound according to at least one of a distance between a pedestrian and a vehicle and a position of the pedestrian; and outputting the pedestrian detection image. The method may further include: at least one of automatically applying the pedestrian recognition function when a pre-set time arrives; automatically applying the pedestrian recognition function when a luminance sensor value is less than or greater than a predetermined value; and automatically applying the pedestrian recognition function when a temperature sensor value is less than or greater than a predetermined value.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary view schematically illustrating a configuration of a device for recognizing a pedestrian and a vehicle including the same according to an exemplary embodiment of the present invention;

FIG. 2 is an exemplary view illustrating a process of recognizing a pedestrian according to an exemplary embodiment of the present invention;

FIG. 3 is an exemplary view specifically illustrating a configuration of a controller of the device for recognizing a pedestrian according to an exemplary embodiment of the present invention;

FIG. 4 is an exemplary flow chart illustrating a method for recognizing a pedestrian according to an exemplary embodiment of the present invention;

FIG. 5 is an exemplary view illustrating a method for determining a pedestrian candidate group according to an exemplary embodiment of the present invention;

FIG. 6 is an exemplary view illustrating a method for determining and normalizing a surrounding area of a pedestrian candidate group according to an exemplary embodiment of the present invention;

FIG. 7 is an exemplary view illustrating an Adv_HOG scheme in pedestrian feature extraction according to an exemplary embodiment of the present invention;

FIG. 8 is an exemplary view illustrating an LBP scheme in pedestrian feature extraction according to an exemplary embodiment of the present invention;

FIG. 9 is an exemplary view illustrating a comparison between pedestrian features according to an exemplary embodiment of the present invention;

FIG. 10 is an exemplary view illustrating an example of positions of Adv_HOG and LBP features, among pedestrian features, in images according to an exemplary embodiment of the present invention; and

FIG. 11 is an exemplary view illustrating a clustering process in pedestrian detection results according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05% or 0.01% of the stated value. Unless otherwise clear from the context, all numerical values provided herein are modified by the term “about.”

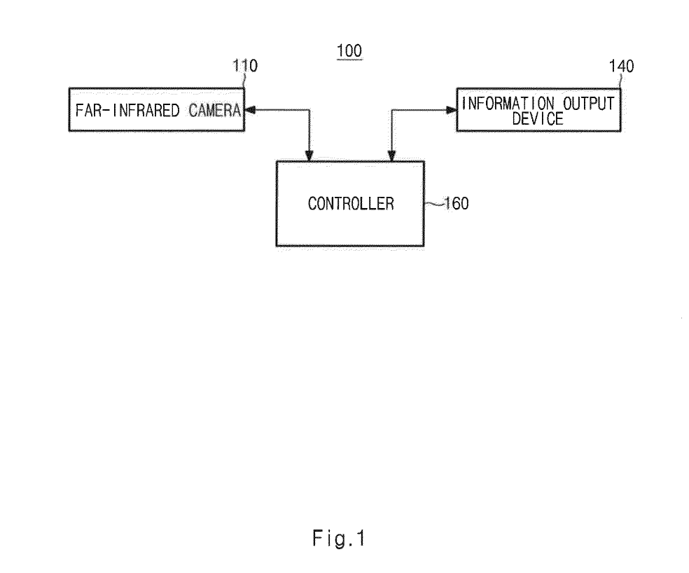

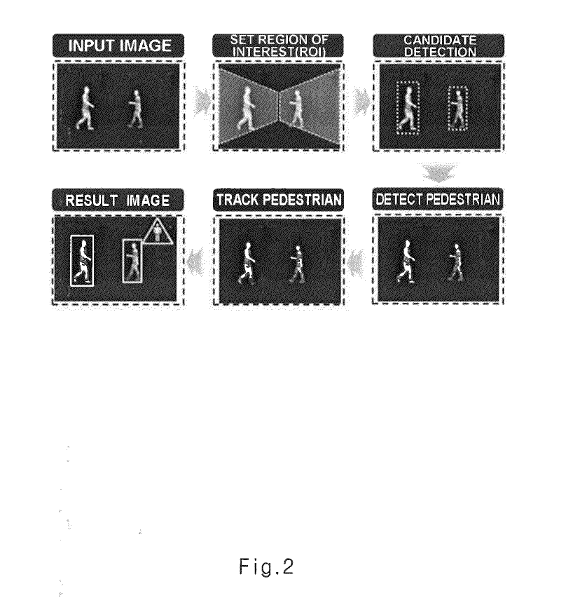

Hereinafter, exemplary embodiments of the present invention will be described in detail with reference to the accompanying drawings. FIG. 1 is an exemplary view schematically illustrating a configuration of a device for recognizing a pedestrian and a vehicle including the same according to an exemplary embodiment of the present invention. FIG. 2 is an exemplary view illustrating a process of recognizing a pedestrian according to an exemplary embodiment of the present invention.

Referring to FIG. 1, the device for recognizing a pedestrian (e.g., a pedestrian recognition device) 100 may include a far-infrared imaging device 110 (e.g., a camera, a video camera, or the like) and a controller 160, and may further include an information output device 140. For the pedestrian recognition device 100, in case of a vehicle, the information output device 140 may be an electronic such as an audio/video/navigation (AVN), a cluster, or the like. In particular, in the pedestrian recognition device 100, for a vehicle, the controller 160 may be an element such as a motor control unit (MCU), or the like.

In the pedestrian recognition device 100 including the foregoing elements, the controller 160 may be configured to process a far-infrared image signal collected by the far-infrared imaging device 110 and may be configured to perform a process as illustrated in FIG. 2 to recognize a pedestrian. In other words, the pedestrian recognition device 100 may be configured to perform an image input process, a Region of interest (ROI) process, a candidate detecting process, a pedestrian detecting process, a pedestrian tracking process, and a result image output process.

The far-infrared imaging device 110 may be an element configured to support the image input process of the pedestrian recognition device 100. The far-infrared imaging device 110 may be configured to collect a far-infrared image with respect to a surrounding environment in a predetermined direction, for example, within a range at a predetermined angle ahead of a vehicle under the operation of the controller 160. Accordingly, the far-infrared imaging device 110 may be disposed at a predetermined position on the roof or a bonnet (e.g., a hood) of a vehicle. An image collected by the far-infrared imaging device 110 may be obtained in real time or in predetermined periods of time. The far-infrared image collected by the far-infrared imaging device 110 may be delivered to the controller 160.

The information output device 140 may be a device configured to output a pedestrian recognition result under the operation of the controller 160. The information output device 140 may include at least one of an audio device and a video device disposed within the vehicle as mentioned above. Additionally, the information output device 140 may include a cluster device. Thus, the pedestrian recognition result may be output in the form of an audio signal, text, an image, or flickering of a lamp. Accordingly, the information output device 140 may include a guidance message and guidance pattern information previously defined and to be output based on the pedestrian recognition results. To store the guidance message and the guidance patter information, the information output device 140 may further include a memory device. For example, the information output device 140 may be configured to output a number of pedestrians present ahead of the vehicle (e.g., or surrounding the vehicle), a distance between a pedestrian and the vehicle, an alarm message based on the distance between a pedestrian and the vehicle, and the like, according to a pedestrian recognition result. The number of pedestrians, the distance between a pedestrian and the vehicle, and the alarm message, and the like, may be output in various forms such as a guidance sound, a guidance text, a guidance image, a lamp pattern, and the like, in predefined forms. In addition, the video device of the information output device 140 may be configured to display the pedestrian recognition results based on the far-infrared image.

The controller 160 may be configured to operate the device to support the pedestrian recognition function according to an exemplary embodiment of the present invention and execute signal processing and data processing and delivery, output, and the like. For example, the controller 160 may be configured to receive an input signal to set a pedestrian recognition mode, activate the far-infrared imaging device 110, collect the far-infrared images, recognize a pedestrian in a far-infrared image, and output pedestrian recognition results. In this process, as illustrated in FIG. 2, the controller 160 may be configured to perform an image input process, Region of Interest (ROI) setting process, a candidate detecting process, a pedestrian detecting process, a pedestrian tracking process, and a result image output process. To perform the image input process, the controller 160 may be configured to activate the far-infrared imaging device 110 and operate the far-infrared imaging device to capture an infrared image in real time or at predetermined periods of time.

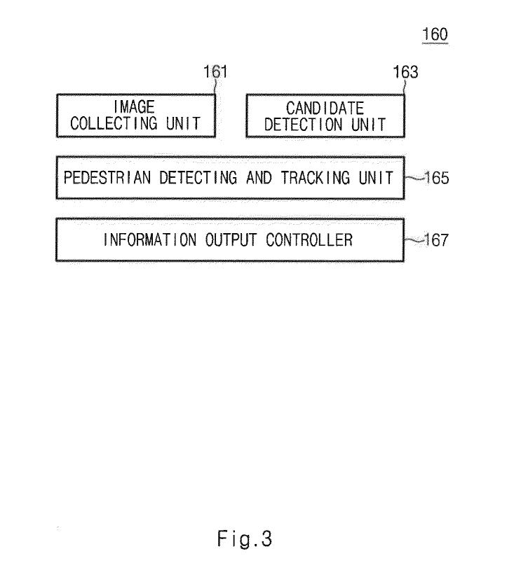

When a far-infrared image is obtained in the region of interest setting process, the controller 160 may be configured to set a predefined area as a region of interest or may be configured to schematically detect an object from a far-infrared image obtained by performing filtering, or the like to set a region of interest. When the region of interest is set, the controller 160 may be configured to determine a candidate area for pedestrian recognition in the region of interest in the candidate detecting process. When a candidate area is determined, the controller 160 may be configured to detect an object that is walking in actuality (e.g., a moving pedestrian) in candidate areas in the pedestrian detecting process. Thereafter, the controller 160 may be configured to perform tracking on the moving object in the pedestrian tracking process and output the results in a resultant image process. Accordingly, the contoller 160 may include elements as illustrated in FIG. 3. In addition, the pedestrian recognition device 100 or the vehicle including the same may include an input device configured to set or enter a pedestrian recognition mode. In particular, the input device may include various input units, for example, at least one key button, at least one touch key, or the like.

FIG. 3 is an exemplary view specifically illustrating a configuration of the controller according to an exemplary embodiment of the present invention. Referring to FIG. 3, the controller 160 may include an image collecting unit 161, a candidate detecting unit 163, a pedestrian detecting and tracking unit 165, and an information output controller 167. When the pedestrian recognition mode is set or when an input signal for requesting execution of the pedestrian recognition function is generated, the image collecting unit 161 may be configured to activate the far-infrared imaging device 110. The image collecting unit 161 may be configured to deliver the far-infrared image obtained by the far-infrared imaging device 110 to the candidate detection unit 163.

The candidate detecting unit 163 may be configured to detect a candidate area with respect to a pedestrian area by performing filtering on the far-infrared image collected by the far-infrared imaging device 110 and an object detecting process. Accordingly, the candidate detecting unit 163 may be configured to set a region of interest (RO) with respect to the far-infrared image. In particular, the candidate detecting unit 163 may be configured to set a predetermined area of the obtained far-infrared image, for example, a predetermined area previously defined as an area in which an accident may occur in a vehicle entering process, as a region of interest. Alternatively, the candidate detecting unit 163 may be configured to perform schematic filtering on the obtained far-inflated image and set an area in which predetermined objects are disposed, as a region of interest. The candidate detecting unit 163 may be configured to determine whether predetermined objects are disposed within the region of interest by performing filtering on the set of region of interest. When objects having a size equal to or greater than a predetermined size are detected within the region of interest, the candidate detecting unit 163 may be configured to set the corresponding objects as candidate areas. The candidate detecting unit 163 may be configured to transmit information regarding the extracted candidate areas to the pedestrian detecting and tracking unit 165.

The pedestrian detecting and tracking unit 165 may be configured to perform pedestrian detection on the candidate areas delivered from the candidate detecting unit 163. Accordingly, the pedestrian detecting and tracking unit 165 may be configured to extract pedestrian features from a database (DB) for pedestrian recognition that have the pedestrian features stored therein in advance, and compare the features with currently delivered candidate areas. The pedestrian detecting and tacking unit 165 may be configured to set areas including the pedestrian features, among the candidate areas, as pedestrian areas. After setting the pedestrian areas, the pedestrian detecting and tracking unit 165 may be configured to perform tracking on the set pedestrian areas. In the pedestrian tracking process, the pedestrian detecting and tracking unit 165 may be configured to calculate information regarding a distance between a pedestrian and a vehicle, and the like, and deliver the calculated information to the information output controller 167.

The information output controller 167 may be configured to operate the information output device 140 to output at least a portion of the information regarding particular pedestrian areas being tracked by the pedestrian detecting and tracking unit 165. For example, the information output controller 167 may be configured to operate the information output device 140 to output an alarm message with respect to a pedestrian area in which a distance between a pedestrian and the vehicle is within a predetermined distance, among pedestrian areas. Alternatively, the information output controller 167 may be configured to operate the information output device 140 to output information regarding the recognized pedestrian areas as a video signal such as an image, a message, or the like.

In addition, the vehicle including the pedestrian recognition device 100 may further include a vehicle speed controller. When a distance between a recognized pedestrian and the vehicle is within a predetermined distance, the vehicle may automatically adjust a vehicle speed to be reduced. That is, the vehicle speed controller may be configured to automatically reduce the vehicle speed when an object is detected within a predetermined distance from the vehicle. Further, the vehicle including the pedestrian recognition device 100 may further include an alarm sound output device as the information output device 140 configured to output an alarm sound for a pedestrian to recognize the approaching vehicle. When a distance between a pedestrian and the vehicle is within a predetermined distance, the vehicle may automatically output an alarm sound to alert the pedestrian of the approaching vehicle.

Moreover, the pedestrian recognition device 100 according to an exemplary embodiment of the present invention may further include at least one of a timer, a luminance sensor, and a temperature sensor. The pedestrian recognition device 100 may be configured to execute a pedestrian recognition mode to be automatically performed based on luminance sensor information and temperature sensor information collected by the luminance sensor and the temperature sensor. For example, when a particular time set in the timer is received, the pedestrian recognition device 100 may be configured to execute the pedestrian recognition mode automatically. In addition, when an external environment of the vehicle has intensity of illumination lower than or equal to a predetermined level, for example, when the external environment is night (e.g., low lighting, dark lighting, etc.) or when the vehicle is driving through a tunnel or a parking lot the pedestrian recognition device 100 may be configured to execute the pedestrian recognition mode automatically. Further, when an ambient temperature of the vehicle has a temperature level equal to or less than a predetermined temperature level, the pedestrian recognition device 100 may be configured to execute the pedestrian recognition mode automatically. Thus, the pedestrian recognition function according to an exemplary embodiment of the present invention may be supported as a function specified for recognizing a pedestrian at night according to setting of a particular night time or detection of a night environment.

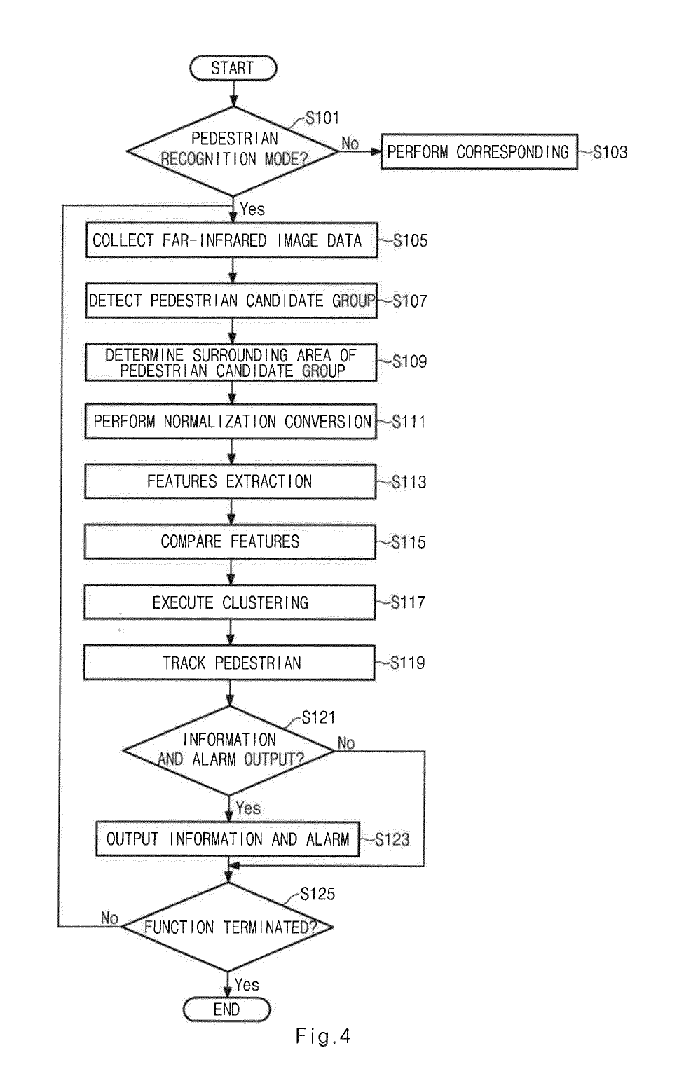

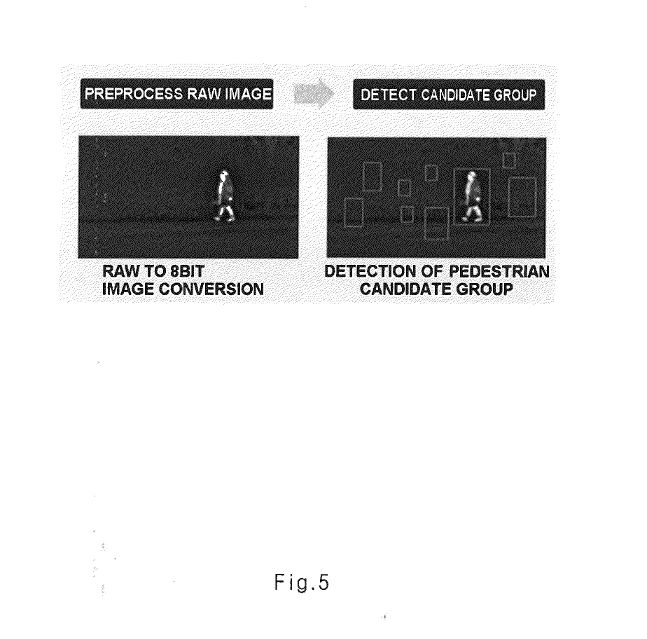

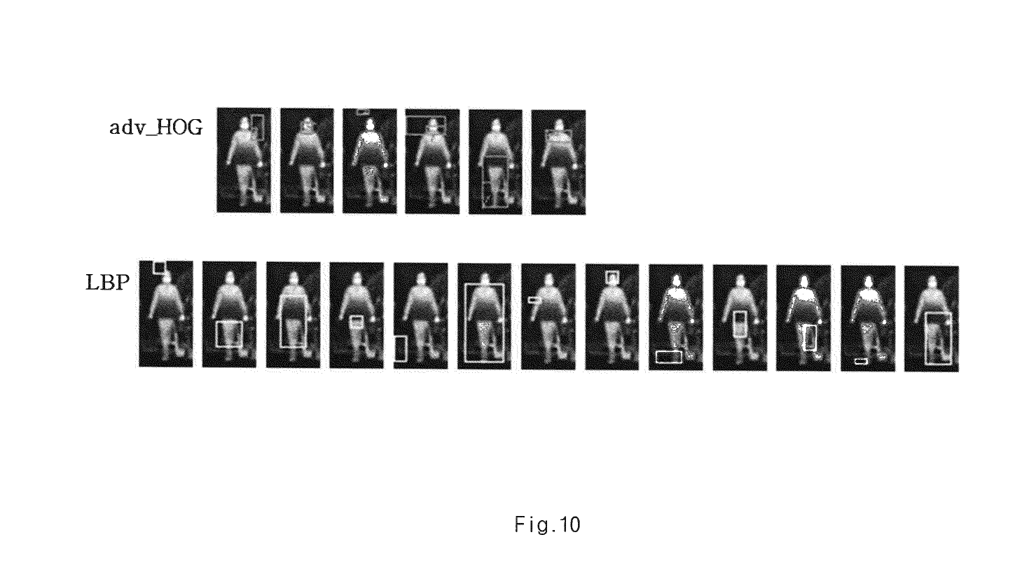

FIG. 4 is an exemplary flow chart illustrating a vehicle operating method as a processing method according to pedestrian recognition and recognition result according to an exemplary embodiment of the present invention. Also, FIGS. 5 through 11 are exemplary views specifically illustrating pedestrian recognition operations.

Referring to FIG. 4, according to a method for processing pedestrian recognition, first, the controller 160 may determine whether the pedestrian recognition device 100 is in a pedestrian tracking mode in operation S101. In this operation, when the pedestrian recognition device 100 is not in the pedestrian tracking mode, the controller 160 may support performing of a corresponding function according to a user manipulation in operation S103. For example, the controller 160 may control a broadcast service output function to be performed or a music play function to be performed according to a user manipulation on the basis of the information output device 140 included in the pedestrian recognition device 100.

In operation S101, a setting for the pedestrian recognition according to an exemplary embodiment of the present invention may be checked as mentioned above. Namely, in a case in which the pedestrian recognition mode is set to be executed only for night-time running, the pedestrian recognition device 100 or the vehicle including the same may include a timer, an luminance sensor, a temperature sensor, and the like, and when a pre-set time arrives, when a situation in which intensity of illumination is lower than or equal to a predetermined level occurs, or when a situation in which a temperature is lower than or equal to a predefined level, the pedestrian recognition device 100 or the vehicle including the same may determine to enter the pedestrian recognition mode.

Meanwhile, when the pedestrian recognition mode is entered, or when an input event for entering the pedestrian recognition mode occurs in operation S101, the controller 160 may control collecting of far-infrared image data in operation S105. To this end, the controller 160 may activate the far-infrared imaging device 110 and control the far-infrared imaging device 110 to be operated in real time or at predetermined periods.

Thereafter, the controller 160 may be configured to detect a pedestrian candidate group in operation S107. As illustrated in FIG. 5, the detection of a pedestrian candidate group may be performed based on an object temperature and a head area (e.g., a portion of the object) of a pedestrian in the far-infrared image. In other words, the controller 160 may be configured to form an image that expresses a temperature area in which a pedestrian is present in the far-infrared image. To detect the head area-based pedestrian candidate group, the controller 160 may be configured to apply vertical and horizontal filters and detect a head area of a pedestrian as a corresponding result. The controller 160 may be configured to estimate a height of the pedestrian by predicting a distance to the ground using the detection results. The controller 160 may also be configured to estimate an overall pedestrian candidate group by drawing a line at the height of the shoulder of the pedestrian through the height of the pedestrian.

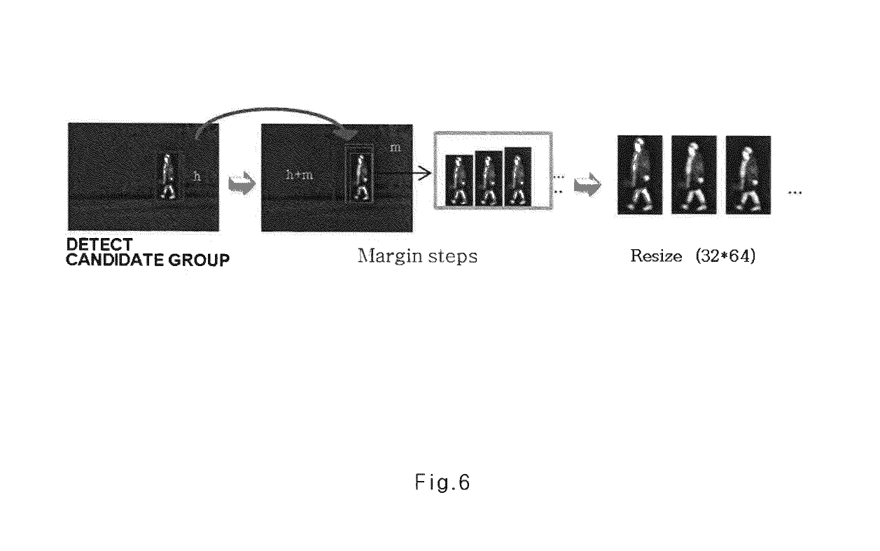

When the detection of a pedestrian candidate group is completed, the controller 160 may be configured to determine surrounding areas of the pedestrian candidate group in operation S109. The operation to determine surrounding areas of the pedestrian candidate group may be a process of determining a predetermined margin with respect to the pedestrian candidate group as illustrated in FIG. 6. In particular, the controller 160 may be configured to perform variable margin selection to determine a predetermined number of margins, for example, five types of margins, per candidate group image. Meanwhile, under the assumption that a height of the pedestrian candidate group image is h and a normalized size of a pedestrian DB image is about 64×32 (height×width), a vertical margin may be determined by Equation 1 as follows.

m=5*h*idx/(64−10) (idx=0,1,2,3,4) [idx are margin steps] Equation 1

Wherein, m may be a vertical margin. When the vertical margin is determined, the controller 160 may be configured to determine a horizontal margin proportionally. For example, when a height of the pedestrian is determined as m+h, a horizontal margin may be determined to have a width equal to (m+h)/2 from about the center of the pedestrian. To determine surrounding areas, the pedestrian recognition device 100 may be configured to store normalized pedestrian DB image information in advance.

After surrounding areas of the pedestrian candidate group are determined, the controller 160 may be configured to perform normalization conversion in operation S111. In other words, the controller 160 may be configured to perform image conversion (e.g., resizing) on the currently determined surrounding areas of the pedestrian candidate group to have a normalized size based on the normalized size information calculated from the pedestrian DB images. For example, the controller 160 may be configured to normalize the surrounding areas of the pedestrian candidate group to have a size of about 64×32 equal to that of the pedestrian DB to match the features retrieved from a pedestrian DB to features drawn from the pedestrian candidate group image. The normalized size as mentioned above may be altered based on an image size of the pedestrian DB. In particular, the controller 160 may be configured to maintain a ratio of the normalized size, as a ratio of 1:2 (width:height). Through the normalizing process according to the predetermined ratio, the controller 160 may be configured to draw features over even a change in a size of a pedestrian.

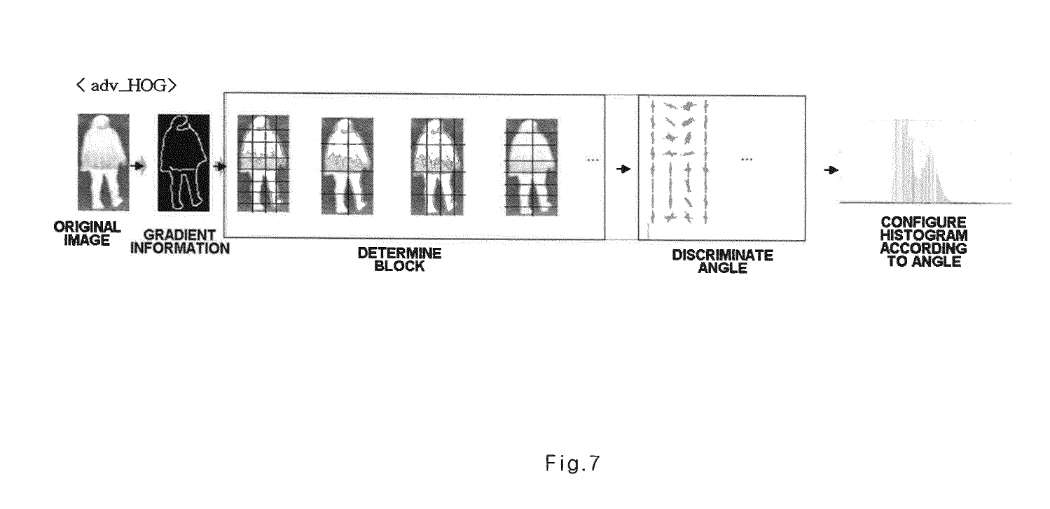

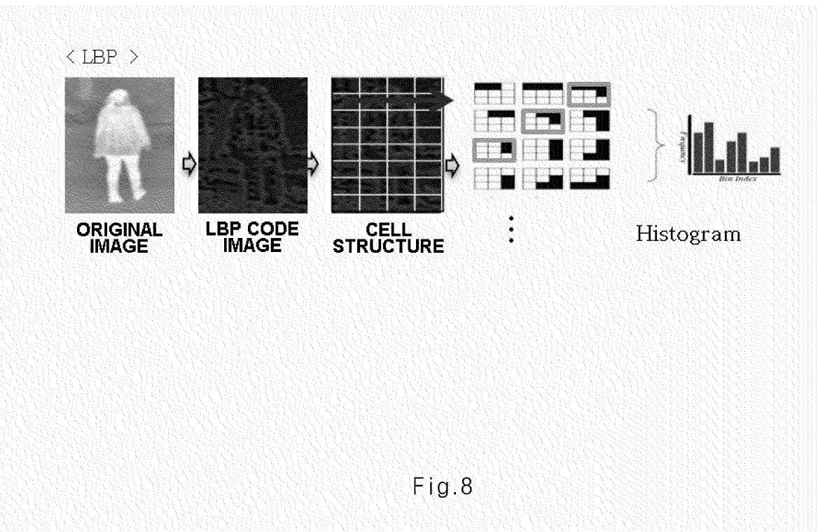

Thereafter, the controller 160 may be configured to extract features in operation S113. To extract the features, the controller 160 may be configured to use at least one of an Adv_HOG (advanced histogram of gradients) scheme of FIG. 7 and an LBP code application scheme of FIG. 8 in which features of the pedestrian are drawn from a feature drawing area to match the features to learned results, thereby drawing more firm, definite features drawn according to pedestrian DB learning results. By using such a scheme, in an exemplary embodiment of the present invention, a degradation of a processing speed due to application of all the features may be improved. In other words, the controller 160 may be configured to draw primary features having improved characteristics, among features, through Adaboost, a substantially weak classifier, during learning and use the same to detect a pedestrian, thus improving a speed while providing similar performance.

For the HOG scheme, features obtained by normalizing sizes may be extracted by configuring a histogram based on gradient angles in a predetermined block of an image. In the related art, gradient values are extracted from a 16×16 (wxh, unit: pixel) block and an angle range from 0 to 180 degrees are divided into nine bins to express angles. In comparison, in the case of the Adv_HOG (advanced histogram of gradients) scheme according to an exemplary embodiment of the present invention as illustrated in FIG. 7, rectangular blocks, in addition to substantially square blocks (8×8) and inducement of a change in size of blocks are supported, and an angle range from about 0 to 360 degrees are configured as nine bins such that a far-infrared image may be more easily altered, thus representing angles.

Meanwhile, a local binary pattern (LBP) scheme illustrated in FIG. 8 is a scheme of calculating a value obtained by pattern changes in a current pixel value and a neighbor pixel value and applying the same. In particular, the histogram is configured in each block to normalize and extract features, rather than applying the patterned value. Further size of each block may vary. In other words, each block may have a substantially square or rectangular shape, rather than having an existing fixed square shape in the same manner as in the Adv_HOG scheme, whereby the present invention supports more robust feature drawing.

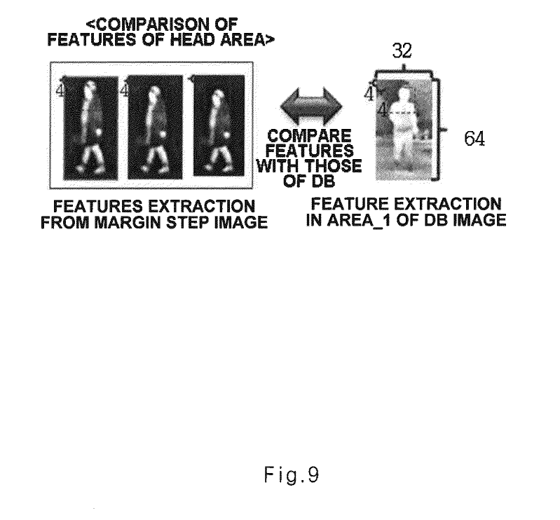

After the feature extraction, the controller 160 may be configured to perform features in operation S115. In this process, the controller 160 may be configured to compare features with the learned results as illustrated in FIG. 9. In other words, the controller 160 may be configured to compare features (e.g., features calculated by applying the Adv_HOG scheme or the LBP scheme) drawn from a real-time image with a pedestrian DB learned result to determine similarity. Particularly, an amount of robust comparison features and feature positions may differ according to the characteristics of the pedestrian DB.

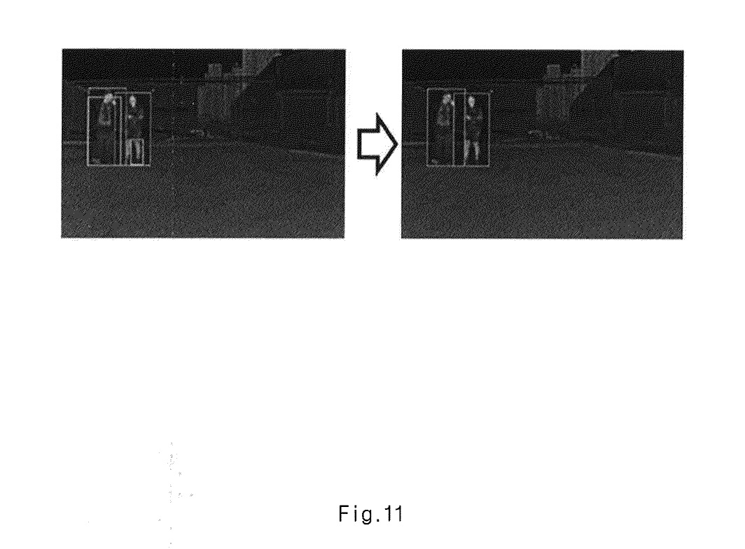

After the feature comparison, the controller 160 may be configured to execute clustering in operation S117. For example, as illustrated in FIG. 11, the controller 160 may be configured to execute overlapping area clustering using the resultant image in which a pedestrian is detected. In particular, when partial areas of a pedestrian overlap to be recognized as a pedestrian, the controller 160 may be configured to determine whether the pedestrian is recognized as the same pedestrian based on an overlap proportion of the overlap areas. In this manner, in an exemplary embodiment of the present invention, a pedestrian may be more clearly detected, and thus, evident information regarding the presence or absence of a pedestrian may be provided to the driver and a tracking algorithm may be more easily applied.

Thereafter, the controller 160 may be configured to perform pedestrian tracking in operation S119. A Kalman filter may be applied for pedestrian tracking. In this process, the controller 160 may be configured to track a movement of the pedestrian using a linear-Kalman filter by applying parameters such as a position, a speed, a feature, and the like, through the pedestrian detection results. By applying the foregoing filter, the controller 160 may be configured to estimate a movement of the pedestrian and remove a non-detected or erroneously detected area.

In operation S121, the controller 160 may be configured to determine whether there is a setting for executing at least one of information and alarm outputs. Accordingly, the controller 160 may be configured to estimate a distance between the pedestrian and the vehicle by using the pedestrian-detected image. In particular, the controller 160 may be configured to estimate the distance between the pedestrian and the vehicle based on the assumption that a position at which the far-infrared imaging device 110 is fixed and the pedestrian is about 170 centimeters tall. The controller 160 may be configured to detect whether the pedestrian is standing at a front side of the vehicle using the area in which the pedestrian is present in the far-infrared image.

When a setting for information and alarm output is detected in operation S121, the controller 160 may be configured to operate and output the predefined information and alarm in operation S123. For example, when the pedestrian is close (e.g., within a predetermined range) to the vehicle or is present in front of the vehicle, the controller 160 may be configured to generate a risk alarm sound. Alternatively, when the pedestrian is present far (e.g., beyond a predetermined range) from the vehicle or on the right or left side ahead of the vehicle, the controller 160 may be configured to indicate (e.g., output) the position of the pedestrian in the image using a video device of the information output device 140.

Moreover, when a setting for information and alarm outputs is not detected in operation S121, the controller 160 may skip operation S123. Thereafter, the controller 160 may be configured to determine whether an event for terminating the pedestrian recognition function occurs in operation S125. For example, when an input signal for terminating the pedestrian recognition function is received, or when illumination sensor information is less than or higher than predetermined intensity of illumination or when temperature sensor information is less than or higher than a predetermined temperature level as mentioned above, the controller 160 may be configured to determine that an event for terminating the pedestrian recognition function has occurred. Further, when the event for terminating the pedestrian recognition function does not occur in operation S125, the controller 160 may return to a previous stage of operation S105 to perform the repeat the above mentioned operations.

As described above, with the device and method for recognizing a pedestrian and the vehicle supporting the same according to exemplary embodiments of the present invention, a pedestrian may be actively recognized when it is difficult to recognize a pedestrian, such as night time (e.g., poor lighting conditions). In this process, a more reliable pedestrian recognition function may be provided through prompt image processing and reliable image recognition. In addition, since a vehicle or alarm may be operated based on the pedestrian recognition results, security and safety of a driver and a pedestrian may be secured. According to the exemplary embodiment of the present invention, a pedestrian may be recognized at an appropriate time reliability using an improved image processing rate and more stable pedestrian feature detection. Thus, safety of a driver and a pedestrian may be improved.

It should be interpreted that the scope of the present invention is defined by the following claims rather than the above-mentioned detailed description and all modifications or alterations deduced from the meaning, the scope, and equivalences of the claims are included in the scope of the present invention.

What is claimed is:

1. A device for recognizing a pedestrian, the device comprising:
a far-infrared imaging device configured to collect a far-infrared image of a predetermined area; and
a controller configured to:
detect a pedestrian candidate group from the far-infrared image; and
draw and compare pedestrian features based on primary features among features detected by a classifier, while learning normalized pedestrian database (DB), to perform pedestrian detection.

2. The device according to claim 1, wherein the controller is configured to perform pedestrian candidate group detection based on temperature information and object information in the far-infrared image.

3. The device according to claim 1, wherein the controller is configured to determine a surrounding area of the pedestrian candidate group detected from the far-infrared image, and normalize the surrounding area of the pedestrian candidate group to have a size of a pedestrian area in the normalized pedestrian DB.

4. The device according to claim 3, wherein the controller is configured to normalize the surrounding area of the pedestrian candidate group to have a size with a ratio of 1:2 of width and height.

5. The device according to claim 1, wherein the controller is configured to apply an Adv_HOG scheme in which the pedestrian candidate group area is divided into square blocks adjustable in size and an angle range of 360 degrees is divided into nine bins to express angles, or apply a local binary pattern (LBP) scheme in which a value obtained by pattern changes in a currnent pixel value and a neighbor pixel value is applied to each block having adjustable size in the pedestrian candidate group area to configure a histogram to draw features.

6. The device according to claim 1, wherein the controller is configured to perform clustering on an area in which objects overlap in the pedestrian detection result image to determine whether a single pedestrian is present or a plurality of pedestrians are present.

7. A vehicle supporting a pedestrian recognition function, the vehicle comprising:
a far-infrared imaging device configured to collect a far-infrared image of a predetermined area;
a controller configured to:
detect a pedestrian candidate group from the far-infrared image; and
draw and compare pedestrian features based on primary features among features detected by a classifier, while learning normalized pedestrian database (DB), to perform pedestrian detection; and
an information output device configured to output the pedestrian detection result.

8. The vehicle according to claim 7, wherein the controller is configured to perform pedestrian candidate group detection based on of temperature information and object information in the far-infrared image, determines a surrounding area of the pedestrian candidate group detected from the far-infrared image, and normalize the surrounding area of the pedestrian candidate group to match the surrounding area to a size of a pedestrian area in the normalized pedestrian DB, and have a size having a ratio of 1:2 of width and height.

9. The vehicle according to claim 7, wherein the controller is configured to apply an Adv_HOG scheme in which the pedestrian candidate group area is divided into square blocks adjustable in size and an angle range of 360 degrees is divided into nine bins to express angles, or apply a local binary pattern (LBP) scheme in which a value obtained by pattern changes in a current pixel value and a neighbor pixel value is applied to each block having adjustable size in the pedestrian candidate group area to configure a histogram to draw features.

10. The vehicle according to claim 7, wherein the controller is configured to perform clustering on an area in which objects overlap in the pedestrian detection result image to determine whether a single pedestrian is present or a plurality of pedestrians are present.

11. The vehicle according to claim 7, wherein the information output device includes at least one of a group consisting of: an audio device configured to output an alarm sound based on at least one of a distance between the pedestrian and a vehicle and a position of the pedestrian and a video device configured to output the pedestrian detection image.

12. The vehicle according to claim 7, further comprising: at least one of a group consisting of: a timer configured to determine a time at which the pedestrian recognition function is automatically applied; an luminance sensor configured to detect ambient intensity of illumination to automatically apply the pedestrian recognition function; and a temperature sensor configured to detect ambient temperature to automatically apply the pedestrian recognition function.

13. A method for recognizing a pedestrian, the method comprising:
collecting, by a controller, a far-infrared image captured by a far-infrared imaging device;
detecting, by the controller, a pedestrian candidate group from the far-infrared image;
extracting, by the controller, pedestrian features based on previously normalized pedestrian database (DB) learning;
comparing, by the controller, the pedestrian features with the pedestrian DB learning results to determine similarity; and
performing, by the controller, pedestrian recognition based on the comparison result.

14. The method according to claim 13, wherein the detecting includes performing, by the controller, the pedestrian candidate group detection based on temperature information and object information from the far-infrared image.

15. The method according to claim 13, further comprising:
determining, by the controller, a surrounding area of the pedestrian candidate group detected from the far-infrared image; and
normalizing, by the controller, the surrounding area of the pedestrian candidate group such to correspond to a size of a pedestrian area in a normalized pedestrian database and have a size with a ratio of 1:2 in width and length.

16. The method according to claim 13, wherein the feature extraction includes:
extracting, by the controller, primary features among features drawn by a classifier during the database learning.

17. The method according to claim 16, wherein the feature extraction includes at least one of:
applying by the controller, an Adv_HOG scheme in which the pedestrian candidate group region is divided into square blocks adjustable in size and an angle range of 360 degrees is configured as 9 bins to express angles; and
applying, by the controller, a local binary pattern (LBP) scheme in which a value obtained by patterning changes in a current pixel value and a neighbor pixel value is applied to each block having adjustable size in the pedestrian candidate group area to configure a histogram to draw features.

18. The method according to claim 13, further comprising:
determining, by the controller, whether a single pedestrian is present or a plurality of pedestrians are present with respect to an area in which detection objects overlap in the pedestrian detection result image.

19. The method according to claim 13, further comprising at least one of:
outputting, by the controller, an alarm sound based on at least one of a distance between a pedestrian and a vehicle and a position of the pedestrian; and
outputting, by the controller, the pedestrian detection image.

20. The method according to claim 13, further comprising at least one of:
automatically applying, by the controller, the pedestrian recognition function when a pre-set time is reached;
automatically applying, by the controller, the pedestrian recognition function when an luminance sensor value is less than or grater than a predetermined value; and
automatically applying, by the controller, the pedestrian recognition function when a temperature sensor value is less than or greater than a predetermined value.
